(19) United States
(12) Patent Application Publication
(10) Pub. No.: US 2011/0097473 A1
(43) Pub. Date: Apr. 28, 2011

(54) Method for Refining Natural Oil

(75) Inventors: Katsuro Nakamura, Tokyo (JP); Kazuhiro Suzuki, Tokyo (JP)

(73) Assignee: for-C Co. Ltd., Tokyo (JP)

(21) Appl. No.: 12/982,471

(22) Filed: Dec. 30, 2010

Related U.S. Application Data
(63) Continuation of application No. PCT/JP2009/062358, filed on Jul. 7, 2009.

(30) Foreign Application Priority Data
Jul. 7, 2008 (JP) 2008-176802

(51) Int. Cl. A23D 9/007; A23D 9/04

(52) U.S. Cl. 426/601; 426/417

(57) ABSTRACT

Provided is a method for purifying natural oil comprising: supplying a to-be-treated raw natural oil into a reaction tank which is provided with a layer of a particulate photocatalyst, and which is configured to allow the to-be-treated raw natural oil and oxygen and/or hydrogen to pass through the particulate photocatalyst in the layer; and then, while introducing oxygen and/or hydrogen to the inside of the layer of the particulate photocatalyst, causing the raw natural oil to circulate and to come into contact with the particulate photocatalyst, with a temperature inside the reaction tank kept at 40 to 110° C., to thereby purifying the raw natural oil.

### TECHNICAL FIELD

The present invention relates to a method for efficiently purifying natural oil, particularly botanical oil such as camellia oil.

### BACKGROUND ART

Conventionally, the most commonly used method for the purification of botanical oils had been the purification with the application of heat. The heat purification generally includes steps of degumming, deacidification, decolorization, deodorization, and the like. Through these steps, phospholipids, free fatty acids, coloring matters, odorous components, and the like are removed.

However, in this course which involves heating at high temperatures exceeding 200° C., the composition of fatty acids is altered, and trans isomers, which are not present in the original natural composition, are generated. Recent studies conducted in various countries in the world have pointed out that ingestion of the trans fatty acids negatively affects the health. In this respect, laws which impose an obligation of the presence or absence of trans fatty acids in edible oils have been enforced initially in Europe, and then in 2005 also in the United States. In Japan as well, the risk of trans fatty acids has been increasingly recognized, and along with this a method has been developed in which botanical oil is purified without generation of trans fatty acid (Patent Document 1). However, methods for purifying oil without heating at high temperature (for example, a purifying method using only activated carbon) require a long period of time to achieve an sufficient purification effect, or result in a low yield, in many cases. Moreover, since those factors increase the costs, the current situation is that these methods should be improved a lot before used actually on a commercial basis.

Patent Document 1: International Patent Application Publication No. WO2007/077913

### DISCLOSURE OF THE INVENTION

### Problem to be Solved by the Invention

Accordingly, an object of the present invention is to provide a method for purifying oil, the method being free from trans fatty acids and being capable of efficiently achieving a high purifying and deodorizing effect.

### Means for Solving the Problem

The inventors of the present application have found that the above-described problem can be solved by purifying oil under a certain temperature condition which involves no excessive heating by use of a particulate photocatalyst to which oxygen and/or hydrogen is introduced. This finding has led to the completion of the present invention.

Specifically, the present invention provides a method for purifying natural oil comprising: supplying a to-be-treated raw natural oil into a reaction tank which is provided with a layer of a particulate photocatalyst, and which is configured to allow the to-be-treated raw natural oil and oxygen and/or hydrogen to pass through the particulate photocatalyst in the layer; and then, while introducing oxygen and/or hydrogen to the inside of the layer of the particulate photocatalyst, causing the raw natural oil to circulate and to come into contact with the particulate photocatalyst, with a temperature inside the reaction tank kept at 40 to 110° C., to thereby purifying the raw natural oil.

The present invention also provides oil purified by the above-described method.

### Effects of the Invention

The present invention makes it possible to obtain a highly purified and deodorized oil at a high yield without by-production of trans fatty acids.

### BRIEF DESCRIPTION OF THE DRAWINGS

FIG. 1 shows an example of a catalytic reactor used in a method of the present invention.

FIG. 2 shows decrease in odor of oils achieved by purifying the oils with air being introduced into a catalyst layer.

FIG. 3 shows decrease in odor of oils achieved by purifying the oils with mixture gases of air and hydrogen being introduced to the catalyst layer.

FIG. 4 shows change in odor of oil with the elapse of time in a case where the oil was purified without introducing oxygen and/or hydrogen to the catalyst layer.

FIG. 5 shows time required for raising the temperature of camellia oil by 10° C. in a case where the camellia oil was heated.

FIG. 6 shows decrease in odor in a case where 140 liters of an oil was purified by use of 50 kg of a catalyst.

### EXPLANATION OF REFERENCE NUMERALS

1. reaction tank
2. particulate photocatalyst
3. oil
4. space
5. circulator pump
6. vacuum pump
7. gas inlet tube
8. aeration filter

### BEST MODES FOR CARRYING OUT THE INVENTION

In a method of the present invention, first, a to-be-treated raw natural oil is supplied into a reaction tank which is provided with a layer of a particulate photocatalyst, and which is configured to allow the to-be-treated raw natural oil and oxygen and/or hydrogen to pass through the particulate photocatalyst in the layer.

The reaction tank used in the present invention means a tank used for performing a catalytic reaction in such a manner that the raw natural oil and the particulate photocatalyst are supplied to the inside of the tank, and brought into contact with each other therein. A person skilled in the art can easily determine a material, dimensions of the tank, and the like suitable for this purpose. In consideration of deterioration of the oil, heating temperature, and the like, a stainless steel can be used as the material, for example.

The raw natural oil usable in the present invention is not particularly limited, and any raw natural oil can be used. However, botanical oil is preferable. Examples of the botanical oil include camellia oils, rapeseed oils, safflower oils, corn oils, soybean oils, and he like. Among the above-described oils, camellia oils such as oils obtained from Camellia oleifera or Camellia japonica are particularly preferable, for example. When botanical oil is used, crude oil (oil obtained by pressing seeds) may be used directly, or oil partially purified in advance with activated carbon or the like may be used.

A person skilled in the art can select any kind of photocatalyst for use in the present invention. Examples of the photocatalyst include titanium oxide, zinc oxide, zirconium oxide, and the like. Among these, titanium oxide is particularly preferable. In addition, in this description, the particulate photocatalyst means a solidified photocatalyst obtained by processing the photocatalyst in a certain size for the purpose of efficient contact with the oil and/or for easy separation of the photocatalyst from the oil after the catalytic reaction. A person skilled in the art can determine an optimum shape and size of the particulate photocatalyst of the present invention. However, a spherical one having a diameter of 3 to 10 mm, more specifically 5 to 8 mm, for example, 5 mm is preferable, and a PIP titanium grid manufactured by FUJI KIHAN CO., LTD can be used, for example.

The particulate photocatalyst is disposed in the reaction tank to form a layer, and configured to allow the to-be-treated raw natural oil and oxygen and/or hydrogen to pass therethrough. With the particulate photocatalyst being disposed like a layer, the oil can be efficiently purified by circulating the oil in the reaction tank so that the oil can repeatedly pass through the particulate photocatalyst. Moreover, this makes it possible to efficiently introduce the oxygen and/or hydrogen to the particulate photocatalyst as will be described later.

A preferable amount of the particulate photocatalyst is 0.5 to 5 kg per kg of the oil, and preferably 1 to 3 kg per kg of the oil. However, since the particulate photocatalyst and the oil can be repeatedly brought into contact with each other by circulating the oil, a person skilled in the art can determine, as appropriate, an appropriate amount in consideration of the relationship with other operational conditions.

Impurities, other than fatty acids, causative of odor are decomposed or reduced by use of the above-described particulate photocatalyst. As a result, a highly purified and deodorized oil can be obtained. Use of the catalyst in place of activated carbon, or use of the catalyst in combination with activated carbon brings advantages such as improvement in yield, shortening of the time for the purifying, reduction in costs, and the like, in comparison with a case where oil is purified with only activated carbon.

In the present invention, then, while oxygen and/or hydrogen is introduced to the inside of the layer of the particulate photocatalyst, the raw natural oil is caused to circulate and to come into contact with the particulate photocatalyst, with a temperature inside the reaction tank kept at 40 to 110° C., to thereby purify the raw natural oil.

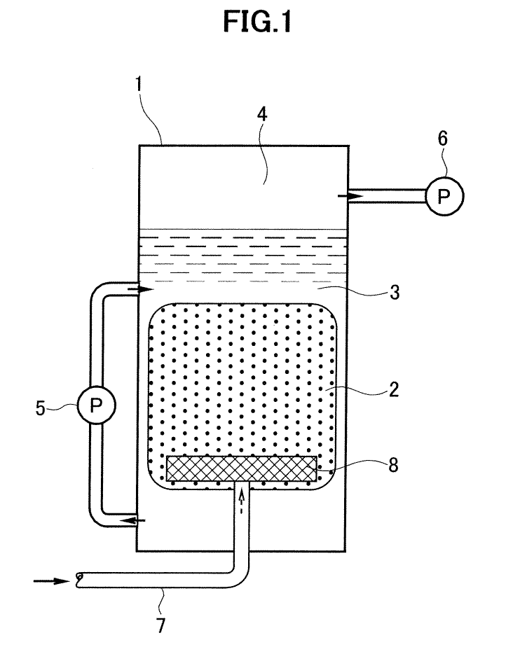

The introduction of the oxygen and/or hydrogen to the inside of the layer of the particulate photocatalyst as described above leads to promotion of the catalytic reaction by the photocatalyst, thereby making it possible to improve the purifying and deodorizing performance thereof. In the present invention, the introduction of the oxygen and/or hydrogen can be performed by, for example, introducing air. Meanwhile, when both oxygen and hydrogen are used, the ratio therebetween can be set to any value. However, the molar ratio therebetween may be 1:10 to 10:1, preferably 1:2 to 2:1, and, for example, approximately 1:1. The method for supplying oxygen and/or hydrogen to the particulate photocatalyst is not particularly limited, but the oxygen and/or hydrogen can be introduced to the inside of the particulate photocatalyst by connecting a gas inlet tube to the particulate photocatalyst from the outside of the tank, for example. At this time, it is possible to employ a method in which the oxygen and/or hydrogen is supplied with a pump, or a method in which the pressure of the inside of the reaction tank is reduced with a vacuum pump, and, by utilizing the resultant suction pressure, oxygen and/or hydrogen is introduced (in other words, evacuation is performed) through the tube, for example. Moreover, it is possible to employ a configuration in which in order to increase an aeration effect, a filter for generating bubbles is disposed at the bottom of the layer of the particulate photocatalyst, and a gas inlet tube for supplying oxygen and/or hydrogen from the outside of the tank is connected to the filter (see FIG. 1). By reducing the pressure the inside of the reaction tank with a vacuum pump as described above, it is made possible to conduct the catalytic reaction efficiently at a relatively low temperature. This reduces the consumption of energy required for raising the temperature of the oil inside the reaction tank. In addition, when the method in which the oxygen and/or hydrogen is introduced through the tube by utilizing the suction pressure is employed, presumably the activation of the molecules is more likely to be induced than in a case of a corresponding pressure, and the catalytic reaction is more easily caused.

In the present invention, oxygen and/or hydrogen obtained by electrolysis of water may be introduced to the layer of the particulate photocatalyst. An apparatus used for the electrolysis of water is not particularly limited, but, for example, AEGIS X manufactured by S.U.E. Engineering Corporation can be used. The oxygen and/or hydrogen obtained by electrolysis of water are collected separately from each other. Then, a method may be employed in which, for example, these gases are mixed with each other at a desired ratio, and then introduced to the layer of the particulate photocatalyst through a pipe by utilizing the suction pressure under reduced pressure; alternatively, these gases may be introduced to the layer of the particulate photocatalyst through their respective pipes.

With the oxygen and/or hydrogen being introduced to the inside of the layer of the particulate photocatalyst as described above, the raw natural oil is caused to circulate and to come into contact with the particulate photocatalyst. By causing the oil to circulate in the reaction tank so that the oil can pass through the particulate photocatalyst repeatedly, the oil can be purified and deodorized efficiently. In an example of a method for circulating the oil, the oil present on the upper side of the layer of the particulate photocatalyst or on the lower side thereof is moved from the lower side to the upper side or from the upper side to the lower side by an effect of a circulator pump provided outside the reaction tank and connected to the reaction tank through piping. As a result, the oil can come into contact with the layer of the particulate photocatalyst by being caused to pass through the layer repeatedly. The amount of the circulation can be determined as appropriate depending on the amounts of the oil and the catalyst, but can be, for example, one to five liters per minute, and, for example, 1.5 liters per minute. When a large reaction tank is used to perform a reaction of the oil in an amount as large as 100 liters to 200 liters, the amount of circulation of the oil can be increased as appropriate, and the amount can be, for example, 0.5 to 2 liters per minute, and for example, about one liter per minute.

In the method of the present invention, the temperature inside the reaction tank is kept at 40 to 110° C., preferably 80 to 110° C., more preferably 85 to 100° C., and particularly preferably approximately 90° C. When the reaction is conducted at a temperature in such preferable ranges, the reaction can be performed efficiently in a short period of time. Meanwhile, in the case of a large scale reaction, the reaction is preferably performed at 40 to 90° C. over a long period of time. Accordingly, in the present invention, the reaction is particularly preferably conducted at 75 to 90° C. The photocatalyst of titanium oxide or the like is known as a substance which exhibits a catalytic effect upon irradiation with light. However, a similar catalytic effect can be obtained also by application of heat. By bringing the oil kept at the above-described temperature into contact with the particulate photocatalyst, decomposition of organic impurity substances contained in the oil can be promoted. By bringing the oil into contact with the particulate photocatalyst at the above-described temperature, the decomposition reduction performance of the photocatalyst can be fully exhibited without the by-production of trans fatty acids.

Note that the present invention utilizes the effect that the catalytic performance can be obtained without irradiation of the photocatalyst with light by employing the above-described temperature condition, but, if necessary, the photocatalyst may be irradiated with light. A person skilled in the art can determine the kind (the combination of wavelength) and the intensity of the light as appropriate depending on the kind, amount, and the like of the catalyst. Examples thereof include ultraviolet rays of varies wavelengths, visible rays, and combinations thereof. Preferably, ultraviolet rays having wavelengths of 315 to 400 nm are used. This makes it possible to obtain a favorable purifying performance.

Meanwhile, in the present invention, the time for which the oil is brought into contact with the layer of the particulate photocatalyst varies depending on operation conditions and the like, and a person skilled in the art can determine an optimal time through a normal operation. However, the time is preferably 4 to 16 hours, and preferably 5 to 8 hours. By employing the above-described time, the oil can be purified sufficiently, and denaturation of the oil and generation of burnt odor, which may occur if the oil is heated for a longer period of time than necessary, can be prevented. Particularly in a catalytic reaction under reduced pressure, denaturation of the oil and generation of burnt odor are less likely to occur. Denaturation the oil and generation of burnt odor, which occurred under corresponding pressure after 6 hours, were not observed even after more than 16 hours.

The above-described method of the present invention makes it possible to highly purify and deodorize raw natural oil such as botanical oil without by-production of trans fatty acids. Moreover, in the method of the present invention, it is possible to easily determine optimal operation conditions which meet the amount to be treated and the like by adjusting a large number of control variables such as the amounts of oxygen and hydrogen supplied to the particulate photocatalyst, the oil circulation time, and the oil temperature.

The degree of the purification of the oil can be determined by using the acid number value of the oil or the odor of the oil as an index, for example. The acid number is one of the numeric values objectively representing the degree of purification of botanical oil, and refers to the amount in mg of potassium hydroxide required to neutralize 1 g of a sample. For example, to 5 g of botanical oil, 25 ml of diethyl ether and 25 ml of ethanol are added, and the botanical oil is dissolved. Then, the solution is titrated with a 0.1-mol/l aqueous solution of potassium hydroxide by use of phenolphthalein as an indicator. The acid number can be calculated from the amount of the aqueous solution of potassium hydroxide required for the neutralization. Meanwhile, for the measurement of the odor, commercially available measuring apparatus can be used, and for example an odor measuring apparatus WB-121F manufactured by ONKAKAGAKU can be used. For example, when camellia oil is purified by the method of the present invention, the oil, which has 110 to 140 points before the purification when measured with the measuring apparatus, can be deodorized to have about 50 points, and even to about 40 points under some conditions. This means that the value of the odor is reduced to 30 to 40% of the initial value. Commercially available conventional oils produced by purification by heating to over 200° C. (i.e., containing a large amount of harmful trans fatty acids) have odor points of, for example, about 35. Accordingly, the method of the present invention can achieve, without performing the treatment at temperature as described above, a deodorization effect comparable to that achieved by conventional purification by heating.

In the present invention, first, measurement of a redox performance of the photocatalyst showed that the highest efficiency was obtained when irradiation with ultraviolet rays having wavelengths of 315 to 400 nm was conducted for promoting the decomposition and reduction of impurities in the raw natural oil. Moreover, it was found that when thermal energy was applied instead of light energy, the decomposition and reduction performance was further enhanced.

In this respect, under a corresponding pressure environment with an upper lid of the reaction tank being open, when the raw natural oil was circulated and brought into contact with the particulate photocatalyst with the temperature of the natural oil inside the reaction tank being kept at 90° C. to 110° C., the same effect obtained by a reaction under ultraviolet irradiation for 24 hours to 48 hours was obtained in 6 to 8 hours.

Moreover, with the upper lid of the reaction tank being closed, the pressure in the space above a surface of liquid was reduced, and simultaneously oxygen and/or hydrogen was introduced through a evacuation hole at the bottom of the reaction tank. In this case, a decomposition and reduction reaction which was equivalent to or better than that achieved under a corresponding pressure environment with the temperature of the oil being 95° C. to 105° C. was achieved with the temperature of the natural oil in the reaction tank being 90° C. or below. The present invention was completed on the basis of the above-described study.

Hereinafter, the present invention will be described more specifically on the basis of Examples. However, the present invention is not limited thereto.

### EXAMPLES

### Example 1

Into a reaction tank (made of stainless steel, having a capacity of 20 liters) 2.3 kg of crude camellia oil obtained by pressing camellia seeds, and 2.3 kg of titanium oxide (PIP titanium grid (spherical shape having a diameter of 5 mm): manufactured by FUJI KIHAN CO., LTD) were introduced. In the reaction tank, the camellia oil was arranged in upper and lower spaces of a layer of the particulate titanium oxide, so that a structure was formed in which the oil passed through the layer of the particulate titanium oxide from the upper side to the lower side repeatedly by circulating the oil with a circulator pump connecting the upper and lower spaces. The circulation amount was 1.5 liters per minute.

The temperature of the oil was set to 90° C. by use of a heater provided to the reaction tank. In addition, by use of a vacuum pump, air in the upper space of the catalytic reaction tank was evacuated with a vacuum pump (degree of vacuum: 30 kPa), and thereby air outside the tank was introduced into the reaction tank, by utilizing suction pressure, through a pipe led through the bottom of the reaction tank and connected to the titanium oxide layer. Moreover, the air was discharged to the oil inside the reaction tank through an evacuation filter for uniformly supplying air to the titanium oxide layer. In addition, before introduced into the tank, the air was humidified with a humidifier.

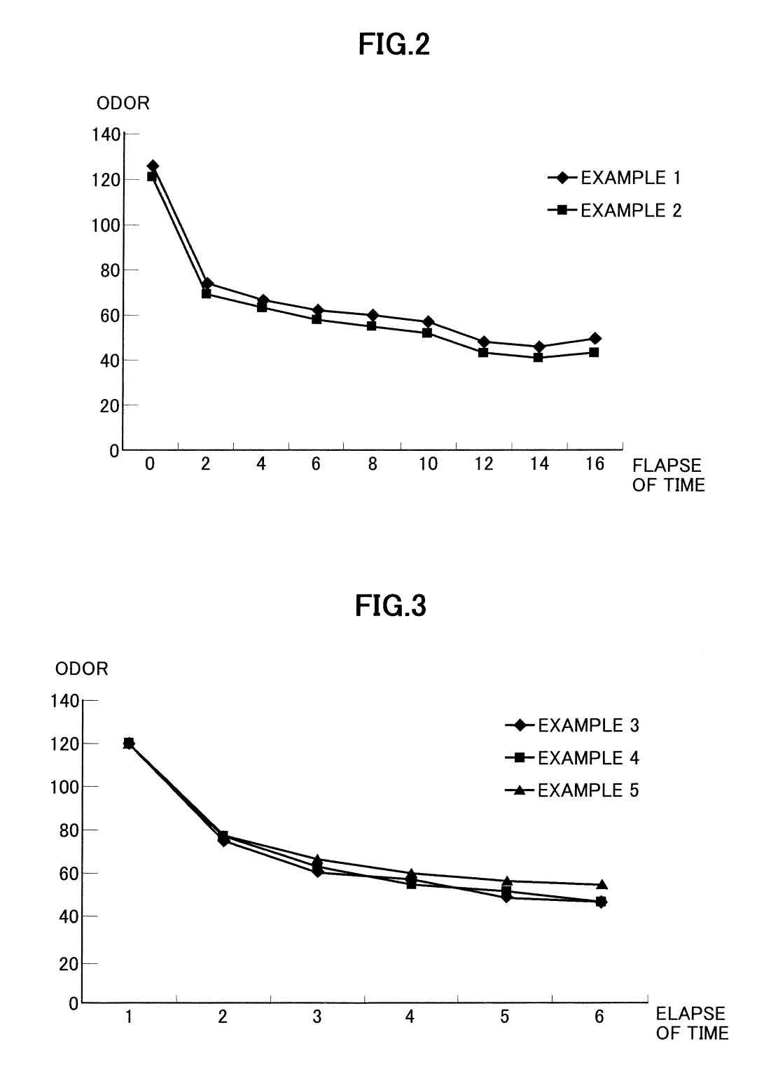

Every 2 hours, an aliquot of the oil was sampled. In a ventilated room at room temperature of 24° C., each sample was placed in a 20-cm³ glass case isolated from the outside air. An odor measuring apparatus WB-121F manufactured by ONKAKAGAKU was stabilized by being left for 30 minutes after start-up thereof. Then, odor of the sample was measured in the glass case. As a result, the value of odor of the crude oil was 126 points initially, 74 points after 2 hours had elapsed, 67 points after 4 hours had elapsed, 62 points after 6 hours had elapsed, 60 points after 8 hours had elapsed, 57 points after 10 hours had elapsed, 48 points after 12 hours had elapsed, 46 points after 14 hours had elapsed, and 50 points after 16 hours had elapsed. After 14 hours had elapsed, the value was reduced to 36.51% of the initial value (FIG. 2).

### Example 2

An experiment was conducted again under the same conditions as in Example 1. The value of odor of the crude oil was 126 points initially, 69 points after 2 hours had elapsed, 63 points after 4 hours had elapsed, 58 points after 6 hours had elapsed, 55 points after 8 hours had elapsed, 52 points after 10 hours had elapsed, 43 points after 12 hours had elapsed, 41 points after 14 hours had elapsed, and 43 points after 16 hours had elapsed. After 14 hours had elapsed, the value was reduced to 33.88% of the initial value (FIG. 2).

As is shown in Examples 1 and 2 described above, the supply of air to the photocatalyst by aeration enabled efficient deodorization of the oil. In addition, even when the catalytic reaction is conducted for more than 6 hours, burnt odor as shown in Comparative Example described later did not occur in the oil.

### Example 3

An experiment was conducted in the same manner as in Example 1, except that a mixture gas of air and hydrogen was introduced to the layer of titanium oxide.

AEGIS X manufactured by S. U. E. Engineering Corporation was used as a water electrolysis apparatus. The obtained hydrogen (approximately 10 liters per minute) was mixed with air, and the mixture was introduced to the layer of titanium oxide. The oil was circulated in the tank, and thereby brought into contact with titanium oxide. Aliquots of the oil were sampled at one-hour intervals from one hour later to five hours later, and the odor thereof was measured with the odor measuring apparatus. The value of odor of the crude oil was 120 points initially, 75 points after 1 hour had elapsed, 61 points after 2 hours had elapsed, 57 points after 3 hours had elapsed, 49 points after 4 hours had elapsed, and 47 points after 5 hours had elapsed. After 5 hours had elapsed, the value was reduced to 39.2% of the initial value (FIG. 3).

### Example 4

An experiment was conducted again under the same conditions as in Example 3. The value of odor of the crude oil was 120 points initially, 77 points after 1 hour had elapsed, 63 points after 2 hours had elapsed, 55 points after 3 hours had elapsed, 51 points after 4 hours had elapsed, and 47 points after 5 hours had elapsed. After 5 hours had elapsed, the value was reduced to 39.2% of the initial value (FIG. 3).

### Example 5

For the purpose of comparison with Examples 3 and 4, an experiment in which only air was supplied to titanium oxide was conducted. The oil was sampled in the same time course, and the odor thereof was measured. The value of odor of the crude oil was 120 points initially, 78 points after 1 hour had elapsed, 67 points after 2 hours had elapsed, 60 points after 3 hours had elapsed, 56 points after 4 hours had elapsed, and 55 points after 5 hours had elapsed. After 5 hours had elapsed, the value was reduced to 45.8% of the initial value (FIG. 3).

As shown in Examples 3 to 5, it was found that, by supplying the mixture gas of air and hydrogen to the catalyst layer, the odor was reduced in a shorter period of time more effectively than by supplying only air.

### Comparative Example 1

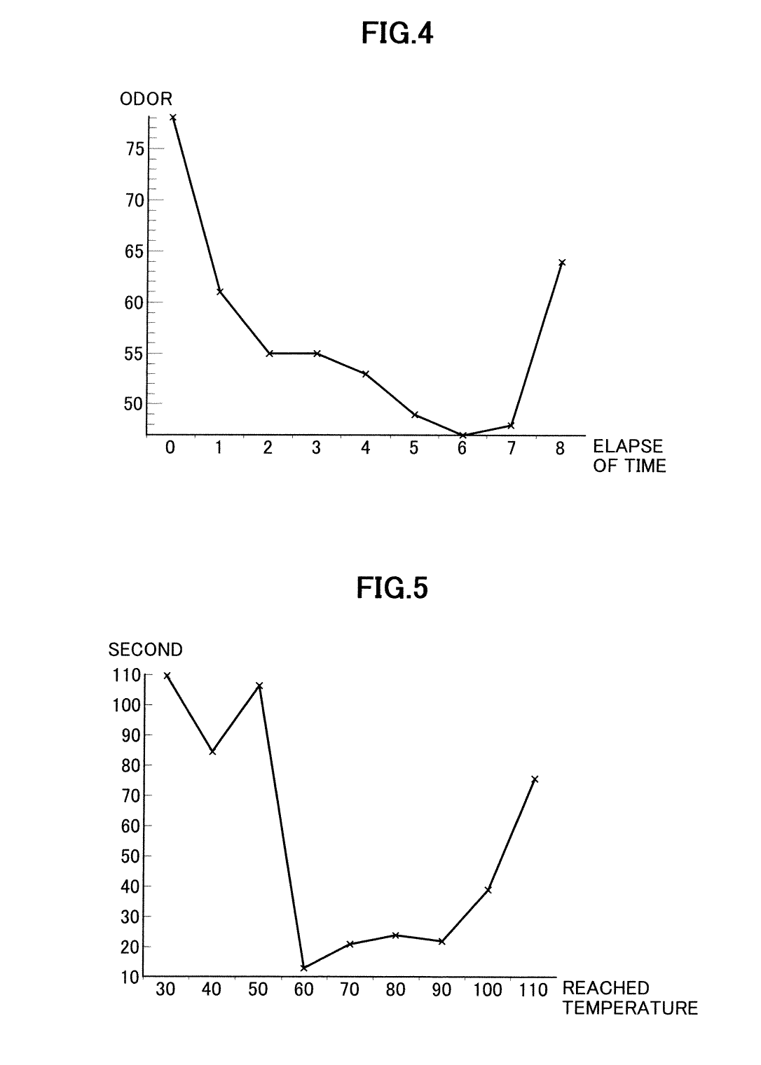

Under conditions where no oxygen and/or hydrogen were introduced to the titanium oxide layer, camellia oil was brought into contact with titanium oxide. Into the reaction tank, 2.3 kg of titanium oxide, 2.3 kg of pressed camellia oil (crude oil) were introduced. The temperature of the oil was set to 90° C. Under a corresponding pressure, a catalytic reaction was conducted by bringing the oil into contact with the titanium oxide with stirring by using a stirrer. The odor of the oil sampled every one hour was measured. The value of odor of the crude oil was 78 points, which was lowered to 47 points in 6 hours, but thereafter the value of the odor was increased. The deodorization percentage was 60.3% of the initial value at the stage 6 hours later, and the value of the odor was further sharply increased 8 hours later (FIG. 4).

Note that the odor included burnt odor which was different from the odor of the original crude oil.

### REFERENCE EXAMPLE

To investigate the resistance of the camellia oil against heating, the time (seconds) required to raise the temperature of the camellia oil by 10° C. when the camellia oil at 20° C. was heated by a constant heat source was measured. As a result, it was shown found that the temperature of the oil was increased by 10° C. in about 20 seconds in a temperature range from 60 to 90° C., but in a temperature range thereabove the amount of heat required was greatly increased (FIG. 5). This is presumably because the resistance of the oil to heat greatly varied. It is conceivable that particularly a high temperature exceeding 100° C. results in denaturation of the camellia oil. For this reason, presumably, the purification can be conducted without generation of the burnt odor, for example, if the camellia oil is brought into contact with the titanium oxide at a temperature of 100° C. or below, and preferably 90° C. or below. Reference Example verifies that the promotion of the catalytic reaction under reduced pressure has an effect of suppressing the generation of burnt odor due to contact with air.

### Example 6

Into a 200-liters reaction tank, 140 liters (128 kg) of camellia oil and 50 kg of titanium oxide were introduced, and the oil was processed. The amount of the circulation of the oil was one liter per second, and a mixture gas of air and hydrogen (1:1 in molar ratio) was supplied to the catalyst in the reaction tank at ten liters per minute. The temperature of the oil was set to 80° C.

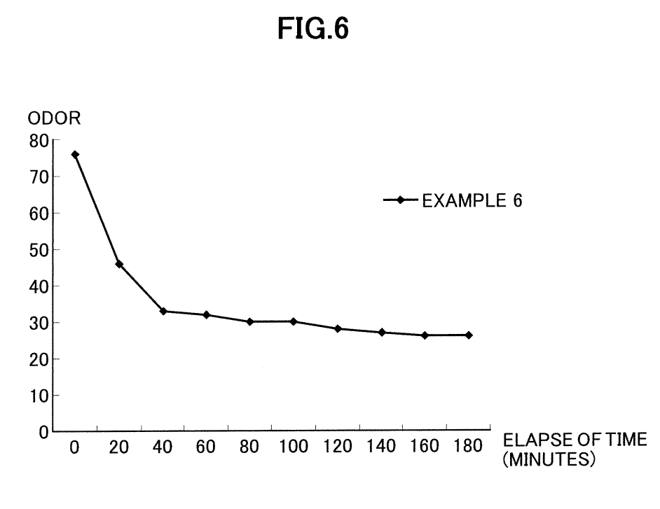

An aliquot of the oil was sampled every 20 minutes, and measured for odor points. The value of odor of the crude oil was 76 points initially, and 26 points after 180 minutes had elapsed. The value was reduced to 36.8% of the initial value (FIG. 6).

1. A method for purifying natural oil comprising:
supplying a to-be-treated raw natural oil into a reaction tank which is provided with a layer of a particulate photocatalyst, and which is configured to allow the to-be-treated raw natural oil and oxygen and/or hydrogen to pass through the particulate photocatalyst in the layer; and
then, while introducing oxygen and/or hydrogen to the inside of the layer of the particulate photocatalyst, causing the raw natural oil to circulate and to come into contact with the particulate photocatalyst, with a temperature inside the reaction tank kept at 40 to 110° C., to thereby purifying the raw natural oil.

2. The method according to claim 1, wherein the photocatalyst is titanium oxide.

3. The method according to claim 1, wherein the raw natural oil and the particulate photocatalyst are brought into contact with each other for 4 to 16 hours.

4. The method according to claim 1, wherein the oxygen and/or hydrogen are humidified.

5. The method according to claim 1, wherein the amount of the oxygen and/or hydrogen introduced to the particulate photocatalyst is controlled by suction pressure which is caused by reducing the pressure inside the reaction tank.

6. The method according to claim 1, wherein the oxygen and/or hydrogen supplied to the particulate photocatalyst are obtained by electrolysis of water.

7. The method according to claim 1, wherein the raw natural oil is botanical oil.

8. The method according to claim 7, wherein the botanical oil is camellia oil.

9. The method according to claim 1, wherein the raw natural oil is purified with the temperature inside the reaction tank kept at 80 to 110° C.

10. The method according to claim 1, wherein the raw natural oil is purified with the temperature inside the reaction tank kept at 40 to 90° C.

11. A natural oil obtained by purification by the method according to claim 1.
